(19) United States
(12) Patent Application Publication
(10) Pub. No.: US 2019/0159566 A1
(43) Pub. Date: May 30, 2019

(54) Eyelash Shaping Assembly

(71) Applicant: Michelle Baldini, San Mateo, CA (US)

(72) Inventor: Michelle Baldini, San Mateo, CA (US)

(21) Appl. No.: 15/827,531

(22) Filed: Nov. 30, 2017

(51) Int. Cl. A45D 2/48; A45D 1/04; A61Q 1/10

(52) U.S. Cl. CPC A45D 2/48; A45D 1/04; A45D 40/265; A45D 2200/157; A61Q 1/10

(57) ABSTRACT

An eyelash shaping assembly for shaping a person's eyelashes includes a housing that has a bottom wall and a perimeter wall that extends upwardly from the bottom wall. An upper edge of the housing defines an opening that is in fluid communication with an interior of the housing. The perimeter wall has a plurality of intake apertures that extend therein to intake ambient air from outside of the housing. A blower is mounted in the housing. The blower draws the ambient air into the housing, heats the ambient air to define warm air and dispends the warm air outwardly from the housing towards a person's eyelashes thereby shaping the eyelashes.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to warm air blowing devices and more particularly pertains to a new warm air blowing device for shaping a person's eyelashes.

### BRIEF SUMMARY OF THE INVENTION

An embodiment of the disclosure meets the needs presented above by generally comprising a housing that has a bottom wall and a perimeter wall that extends upwardly from the bottom wall. An upper edge of the housing defines an opening that is in fluid communication with an interior of the housing. The perimeter wall has a plurality of intake apertures that extend therein to intake ambient air from outside of the housing. A blower is mounted in the housing. The blower is configured to draw the ambient air into the housing, heat the ambient air to define warm air and dispend the warm air outwardly from the housing towards a person's eyelashes thereby shaping the eyelashes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top side view of an eyelash shaping assembly according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is a cross-sectional view of an embodiment of the disclosure taken along line 5-5 of FIG. 3.

FIG. 6 is a bottom view of an embodiment of the disclosure.

FIG. 7 is a front view of an embodiment of the disclosure.

FIG. 8 is a top view of an embodiment of the disclosure.

FIG. 9 is a schematic box diagram of an embodiment of the disclosure.

### DETAILED DESCRIPTION OF THE INVENTION

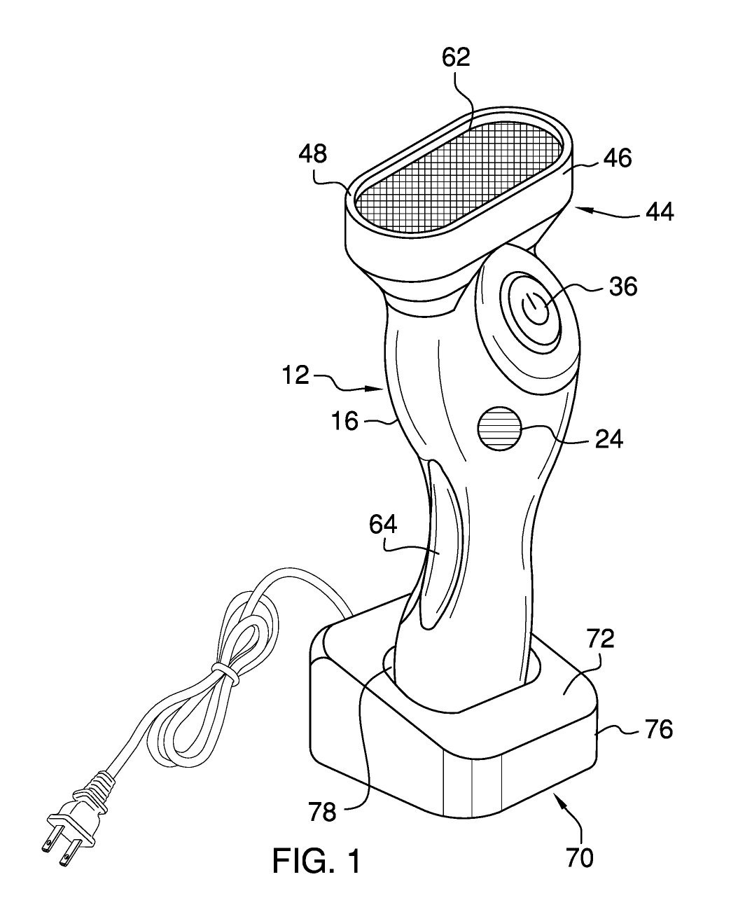

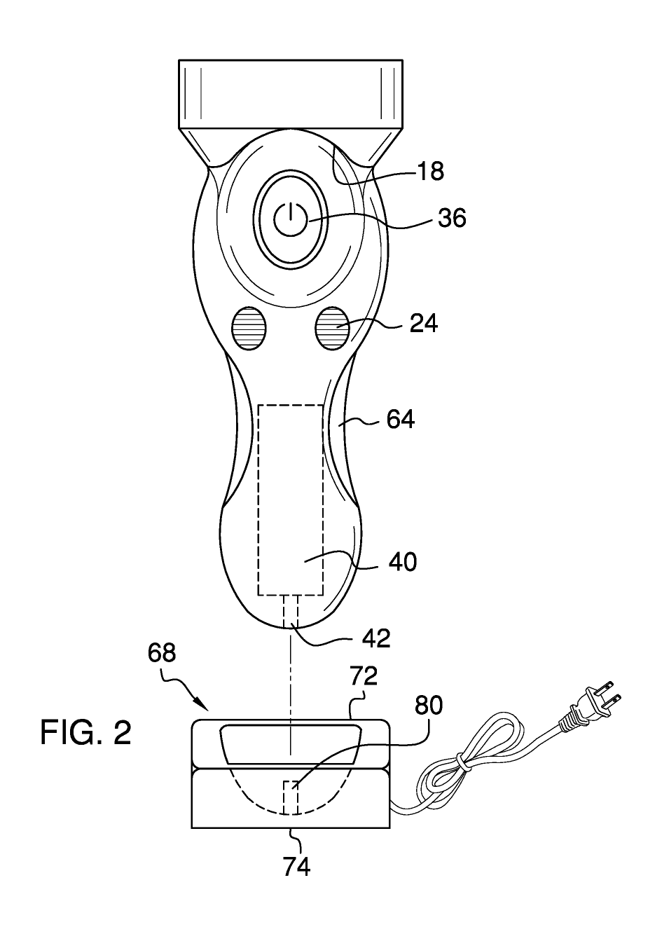

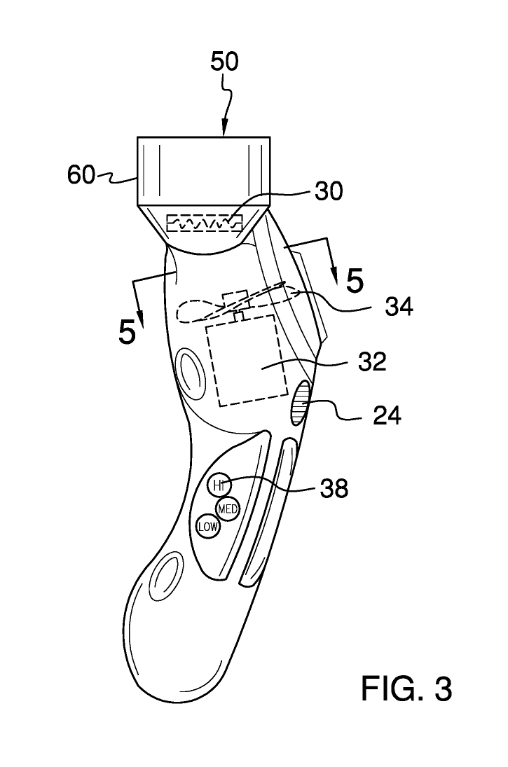

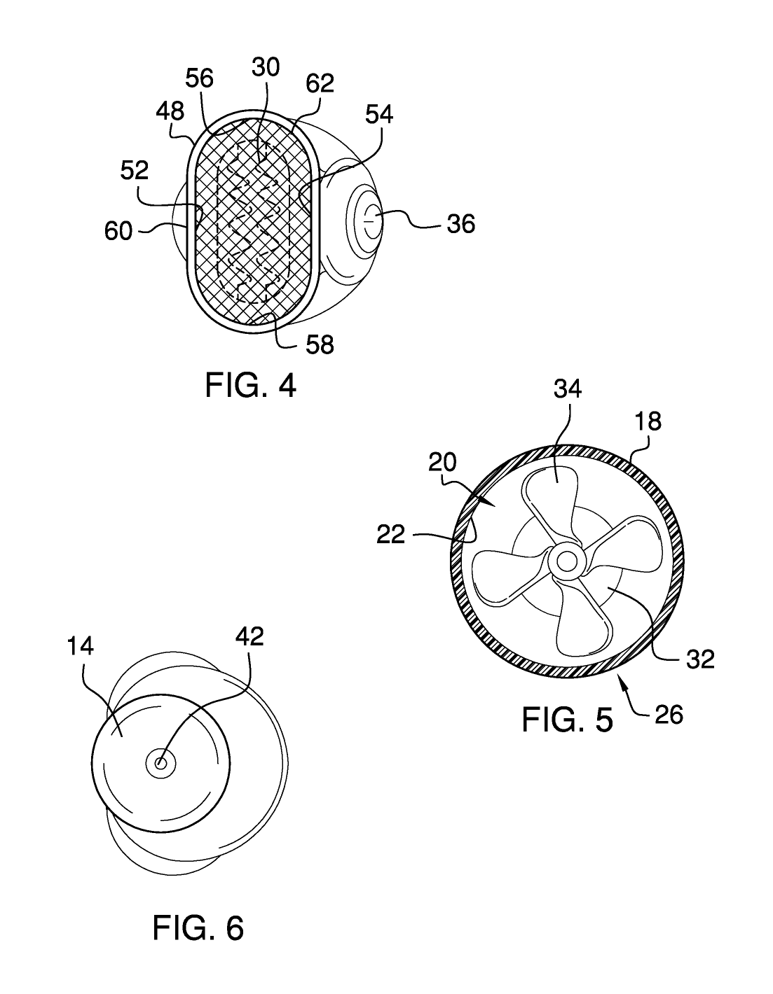

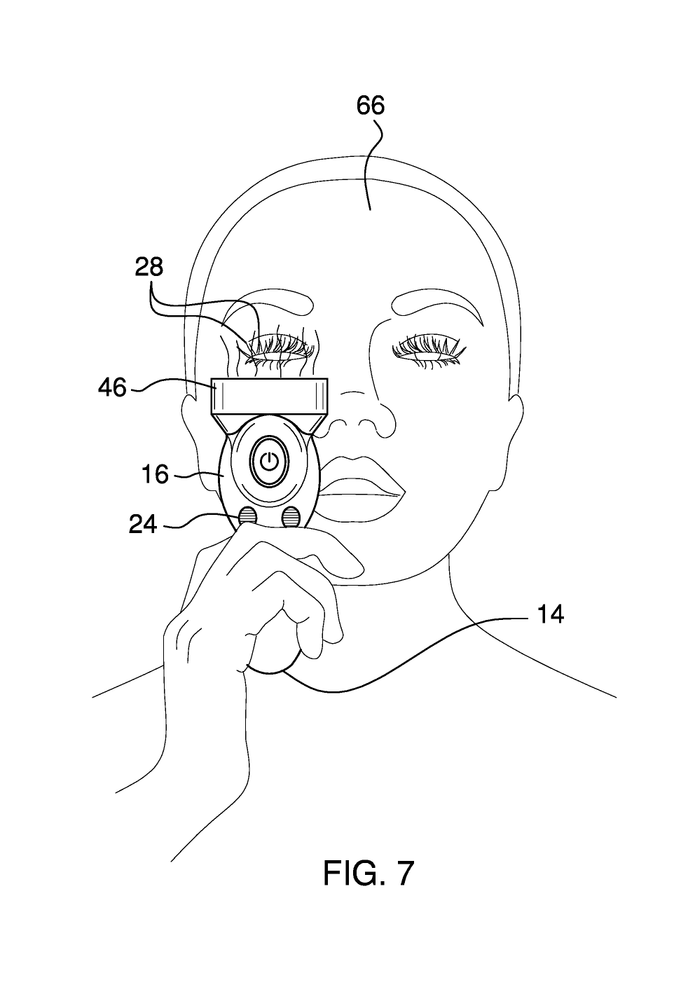

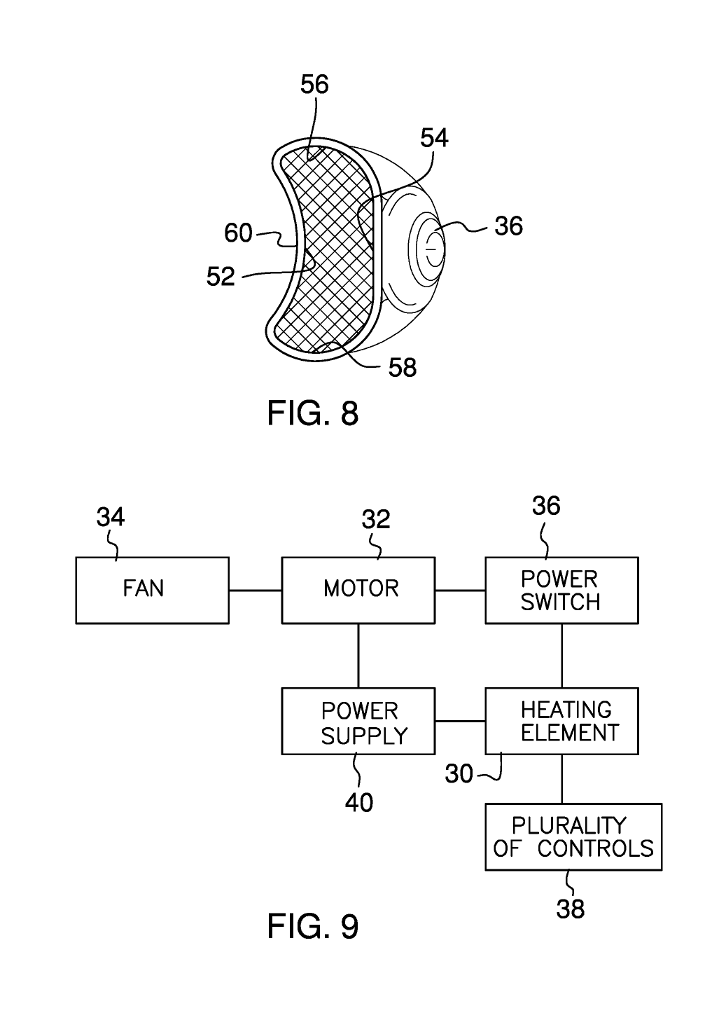

With reference now to the drawings, and in particular to FIGS. 1 through 9 thereof, a new warm air blowing device embodying the principles and concepts of an embodiment of the disclosure and generally designated by the reference numeral 10 will be described.

As best illustrated in FIGS. 1 through 9, the eyelash shaping assembly 10 generally comprises a housing 12 that has a bottom wall 14 and a perimeter wall 16 that extends upwardly from the bottom wall 14. An upper edge 18 of the housing 12 defines an opening 20 that is in fluid communication with an interior 22 of the housing 12. The perimeter wall 16 has a plurality of intake apertures 24 that extend therein to intake ambient air from outside of the housing 12.

A blower 26 is mounted in the housing 12. The blower draws the ambient air into the housing 12, heats the ambient air to define warm air and dispends the warm air outwardly from the housing 12 towards a person's eyelashes 28 thereby shaping the eyelashes 28. The blower 26 includes a heating element 30 that is mounted in the housing 12. The heating element 30 is in thermal communication with the ambient air adjacent to the heating element 30 to define warm air. The heating element 30 is positioned within the housing 12 adjacent to the opening 20. A motor 32 is mounted on the housing 12. A fan 34 is mechanically coupled to the motor 32 such that the fan 34 rotates when the motor 32 rotates. The fan 34 directs the ambient air into the housing 12 from outside each of the intake apertures, across the heating element 30 and dispends the warm air outwardly through the opening 20 toward the eyelashes 28 thereby shaping the eyelashes 28.

A power switch 36 is mounted on the housing 12. The power switch 36 turns the motor 32 on and off. A plurality of controls 38 is mounted on the housing 12 wherein each of the controls 38 controls a temperature of the heating element 30. A power supply 40 is mounted in the housing 12 and is electrically coupled to the motor 32, the heating element 30, the power switch 36 and each of the controls 38. The power supply 40 comprises a rechargeable battery. A first contact 42 is position on the housing 12 and is electrically coupled to the power supply 40.

A vent 44 is positioned on the housing 12 and is in fluid communication with the blower 26. The vent 44 includes a peripheral wall 46 that extends around the opening 20. The peripheral wall 46 has a distal edge 48 with respect to the housing 12 that is open and defines an outlet aperture 50. The peripheral wall 46 includes an inner wall 50, an outer wall 54 and a pair of side walls 56, 58. The inner wall 52 has an outer surface 60 that has a shape that is selected from the shapes that includes planar and concave.

A screen 62 is positioned over the outlet aperture 50. A plurality of grips 64 is positioned on the perimeter wall 16. Each of the grips 64 facilitates the person 66 to hold the housing 12. Each of the grips 64 comprises a resiliently compressible material.

A charger 68 is positioned remote of the housing 12. The charger 68 insertably receives the housing 12 such that the charger 68 is in electrically communication with the power supply 40 to charge the power supply 40. The charger 68 is electrically coupled to a power source. The power source may be an electrical outlet but may be any source of electricity. The charger 68 comprises a base 70 that is positioned on a surface. The base 70 has a top side 72, a bottom side 74 and a peripheral wall 76 that is attached to and extends between the top side 72 and the bottom side 74. The top side 74 has a well 78 extending therein. The well 78 insertably receives the bottom wall 14 of the housing 12. A second contact 80 is mounted on the base 70 and is electrically coupled to the power source. The second contact 80 is electrically coupled to the first contact 42 when the housing 12 is positioned in the well 80 to charge the power supply 40.

In use, the assembly 10 is used to shape a person's eyelashes 28 after the person 66 has applied mascara to the person's eyelashes 28. The power switch 36 is turned on wherein the fan 34 begins to spin taking in ambient air from outside of the housing 12. The temperature of the heating element 30 is selected such that the fan 34 blows the ambient air across the heating element 30 to define warm air. The outlet aperture 50 is positioned below the person's eyelashes 28 such that the warm air exits the housing 12 upwardly towards the eyelashes 28 such that the warm air strikes the eyelashes 28 to shape the eyelashes 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hot air blowing assembly configured to blow warm air on a person's eyelashes to curl the eyelashes, said assembly comprising:
a housing having a bottom wall and a perimeter wall extending upwardly from said bottom wall, an upper edge of said housing defining an opening being in fluid communication with an interior of said housing, said perimeter wall having a plurality of intake apertures extending therein to intake ambient air from outside of said housing;
a blower being mounted in said housing, said blower being configured to draw the ambient air into said housing, said blower being configured heat the ambient air to define warm air and dispending the warm air outwardly from said housing towards a person's eyelashes thereby shaping the eyelashes; and
a vent being positioned on said housing and being in fluid communication with said blower, said vent including a peripheral wall extending around said opening, said peripheral wall having a distal edge with respect to said housing being open and defining an outlet aperture, said peripheral wall including an inner wall, an outer wall and a pair of side walls, said inner wall having an outer surface having a shape being selected from the shapes including planar and concave.

2. The hot air blowing assembly according to claim 1, wherein said blower includes:
a heating element being mounted in said housing, said heating element being configured to be in thermal communication with the ambient air adjacent to said heating element to define warm air, said heating element being positioned within said housing adjacent to said opening;
a motor being mounted on said housing;
a fan being mechanically coupled to said motor such that said fan rotates when said motor rotates, said fan being configured to direct the ambient air into said housing from outside of said aperture, directing the ambient air across said heating element and dispending the warm air outwardly through said opening toward the eyelashes thereby shaping the eyelashes;
a power switch being mounted on said housing, said power switch turning said motor on and off;
a plurality of controls being mounted on said housing, each of said controls controlling a temperature of said heating element; and
a power supply being mounted in said housing, said power supply being electrically coupled to said motor, said heating element, said power switch and each of said controls.

3. The hot air blowing assembly according to claim 2, wherein said power supply comprises a rechargeable battery.

4. The hot air blowing assembly according to claim 1, further including a screen being positioned over said outlet aperture.

5. The hot air blowing assembly according to claim 1, further including a plurality of grips being positioned on said perimeter wall, each of said grips facilitating the person to hold said housing.

6. The hot air blowing assembly according to claim 5, wherein each of said grips comprises a resiliently compressible material.

7. The hot air blowing assembly according to claim 3, further including a charger being positioned remote of said housing, said charger insertably receiving said housing such that said charger is in electrically communication with said power supply to charge said power supply, said charger being configured to be electrically coupled to a power source.

8. The hot air blowing assembly according to claim 7, further including:
a first contact being position on said housing, said first contact being electrically coupled to said power supply;
said charger including a base being configured to be positioned on a surface, said base having a top side, a bottom side and a peripheral wall attached to and extending between said top side and said bottom side, said top side having a well extending therein, said well insertably receiving said bottom wall of said housing, a second contact being mounted on said base, said second contact being electrically coupled to the power source, said second contact being electrically coupled to said first contact when said housing is positioned in said well thereby charging said power supply.

9. A hot air blowing assembly configured to blow warm air on a person's eyelashes to curl the eyelashes, said assembly comprising:
a housing having a bottom wall and a perimeter wall extending upwardly from said bottom wall, an upper edge of said housing defining an opening being in fluid communication with an interior of said housing, said perimeter wall having a plurality of intake apertures extending therein to intake ambient air from outside of said housing;
a blower being mounted in said housing, said blower being configured to draw the ambient air into said housing, said blower being configured heat the ambient air to define warm air and dispending the warm air outwardly from said housing towards a person's eyelashes thereby shaping the eyelashes, said blower including:
a heating element being mounted in said housing, said heating element being configured to be in thermal communication with the ambient air adjacent to said heating element to define warm air, said heating element being positioned within said housing adjacent to said opening;
a motor being mounted on said housing;
a fan being mechanically coupled to said motor such that said fan rotates when said motor rotates, said fan being configured to direct the ambient air into said housing from outside each of said intake apertures, directing the ambient air across said heating element and dispending the warm air outwardly through said opening toward the eyelashes thereby shaping the eyelashes;
a power switch being mounted on said housing, said power switch turning said motor on and off;
a plurality of controls being mounted on said housing, each of said controls controlling a temperature of said heating element;
a power supply being mounted in said housing, said power supply being electrically coupled to said motor, said heating element, said power switch and each of said controls, said power supply comprising a rechargeable battery;
a first contact being position on said housing, said first contact being electrically coupled to said power supply;
a vent being positioned on said housing and being in fluid communication with said blower, said vent including a peripheral wall extending around said opening, said peripheral wall having a distal edge with respect to said housing being open and defining an outlet aperture, said peripheral wall including an inner wall, an outer wall and a pair of side walls, said inner wall having an outer surface having a shape being selected from the shapes including planar and concave;
a screen being positioned over said outlet aperture;
a plurality of grips being positioned on said perimeter wall, each of said grips facilitating the person to hold said housing, each of said grips comprising a resiliently compressible material;
a charger being positioned remote of said housing, said charger insertably receiving said housing such that said charger is in electrically communication with said power supply to charge said power supply, said charger being configured to be electrically coupled to a power source, said charger comprises:
a base being configured to be positioned on a surface, said base having a top side, a bottom side and a peripheral wall attached to and extending between said top side and said bottom side, said top side having a well extending therein, said well insertably receiving said bottom wall of said housing; and
a second contact being mounted on said base, said second contact being electrically coupled to the power source, said second contact being electrically coupled to said first contact when said housing is positioned in said well thereby charging said power supply.

10. A method of curling a person's eyelashes, said method comprising:
providing a housing having a bottom wall and a perimeter wall extending upwardly from said bottom wall, an upper edge of said housing defining an opening being in fluid communication with an interior of said housing, said perimeter wall having a plurality of intake apertures extending therein to intake ambient air from outside of said housing;
providing a blower being mounted in said housing, said blower being configured to draw the ambient air into said housing, said blower being configured heat the ambient air to define warm air and dispending the warm air outwardly from said housing towards a person's eyelashes thereby shaping the eyelashes, said blower including:
a heating element being mounted in said housing, said heating element being configured to be in thermal communication with the ambient air adjacent to said heating element to define warm air, said heating element being positioned within said housing adjacent to said opening;
a motor being mounted on said housing;
a fan being mechanically coupled to said motor such that said fan rotates when said motor rotates, said fan being configured to direct the ambient air into said housing from outside each of said intake apertures, directing the ambient air across said heating element and dispending the warm air outwardly through said opening toward the eyelashes thereby shaping the eyelashes;
a power switch being mounted on said housing, said power switch turning said motor on and off;
a plurality of controls being mounted on said housing, each of said controls controlling a temperature of said heating element;
a power supply being mounted in said housing, said power supply being electrically coupled to said motor, said heating element, said power switch and each of said controls, said power supply comprising a rechargeable battery;
providing a first contact being position on said housing, said first contact being electrically coupled to said power supply;
providing a vent being positioned on said housing and being in fluid communication with said blower, said vent including a peripheral wall extending around said opening, said peripheral wall having a distal edge with respect to said housing being open and defining an outlet aperture, said peripheral wall including an inner wall, an outer wall and a pair of side walls, said inner wall having an outer surface having a shape being selected from the shapes including planar and concave;
providing a screen being positioned over said outlet aperture;
providing a plurality of grips being positioned on said perimeter wall, each of said grips facilitating the person to hold said housing, each of said grips comprising a resiliently compressible material;
providing a charger being positioned remote of said housing, said charger insertably receiving said housing such that said charger is in electrically communication with said power supply to charge said power supply, said charger being configured to be electrically coupled to a power source, said charger comprises:
a base being configured to be positioned on a surface, said base having a top side, a bottom side and a peripheral wall attached to and extending between said top side and said bottom side, said top side having a well extending therein, said well insertably receiving said bottom wall of said housing; and
a second contact being mounted on said base, said second contact being electrically coupled to the power source, said second contact being electrically coupled to said first contact when said housing is positioned in said well thereby charging said power supply.
providing a mascara;
positioning said mascara on said person's eyelashes;
turning on said power switch such said blower takes in ambient air from each of said intake apertures and blows said ambient air across said heating element and outwardly from said housing;
selecting a temperature of said heating element such that said ambient air blown across said heating element and outwardly from said housing is heated defining warm air;
positioning said vent beneath said eyelashes such that said outlet aperture is facing upwardly toward said eyelashes wherein said warm air blows against said eyelashes thereby shaping said eyelashes
turning off said power switch;
placing said housing in said well to charge said power supply.
